(19) United States
(12) Patent Application Publication
(10) Pub. No.: US 2012/0170248 A1
(43) Pub. Date: Jul. 5, 2012

(54) LUMINAIRE ON WHICH LAMP IS MOUNTED WITH CAP

(75) Inventors: Tomonobu MASUKO, Yokosuka-shi (JP); Koji Suzuki, Yokosuka-shi (JP)

(73) Assignee: Toshiba Lighting & Technology Corporation, Yokosuka-shi (JP)

(21) Appl. No.: 13/343,598

(22) Filed: Jan. 4, 2012

(30) Foreign Application Priority Data
Jan. 5, 2011 (JP) 2011-000430
Sep. 27, 2011 (JP) 2011-210947

(51) Int. Cl. F21V 33/00

(52) U.S. Cl. 362/95

(57) ABSTRACT

According to one embodiment, a luminaire includes a lamp unit, a socket and a seal member. The lamp unit has a watertight structure, includes a light-emitting portion and a lighting circuit integrated therein, and is formed with a cap in a range where a plug electrically connected to the lighting circuit projects. The socket has a mounting portion for the cap and a terminal provided on the mounting portion. The terminal is electrically connected to the plug when the cap is coupled to the mounting portion. The seal member is attached along an outer peripheral portion of a joint surface between the cap and the mounting portion, and seals a portion between the lamp unit and the socket with a watertight condition.

### CROSS-REFERENCE TO RELATED APPLICATIONS

This application is based upon and claims the benefit of priority from Japanese Patent Applications No. 2011-000430, filed on Jan. 5, 2011; and No. 2011-210947, filed on Sep. 27, 2011; the entire contents of both of which are incorporated herein by reference.

### FIELD

Embodiments described herein relate generally to a luminaire with protection against ingress of water.

### BACKGROUND

In general, luminaries for narrow places such as inside show cases or under shelves employ flat and thin-type fluorescent lamps as light sources. Instead of the fluorescent lamps, flat LED lamps in which a light emitting diode (LED) as a light-emitting element is employed as a light source are developed and are started being marketed. Also, the LED lamps have a GX53-type cap for achieving general versatility. The luminaries are provided with a socket device corresponding to the GX53-type cap and allow easy replacement of the LED lamp.

The luminaries in which the LED lamp is employed are desired to be used outdoors by taking advantage of the features of the LED such as having a long life and low electric power consumption. In order to be used outdoors, the luminaries must be made waterproof so as to inhibit ingress of rain water.

### BRIEF DESCRIPTION OF THE DRAWINGS

FIG. 1 is an exploded perspective view of a luminaire according to a first embodiment;

FIG. 2 is a cross-sectional view of the luminaire shown in FIG. 1;

FIG. 3A is a side view of a lamp unit of the luminaire shown in FIG. 1;

FIG. 3B is a bottom view of the lamp unit of FIG. 3A;

FIG. 3C is a perspective view of the lamp unit of FIG. 3A viewed from a light-emitting side;

FIG. 3D is a perspective view of the lamp unit of FIG. 3A viewed from a cap side;

FIG. 4A is a plan view of a socket apparatus of the luminaire on FIG. 1 viewed from a side where the lamp is mounted;

FIG. 4B is an enlarged perspective view of a terminal hole of the socket apparatus of the luminaire of FIG. 1;

FIG. 4C is a plan view of the socket apparatus of FIG. 4A viewed from a side of being installed;

FIG. 4D is a perspective view of the socket apparatus of FIG. 4A viewed from the side where the lamp is mounted;

FIG. 4E is a perspective view of the socket apparatus of FIG. 4A viewed from the side of being installed;

FIG. 5A is an exploded perspective view of the luminaire illustrating the lamp unit of FIG. 3A, the socket apparatus of FIG. 4A, and a packing to be mounted therebetween arranged in a line;

FIG. 5B is an exploded perspective view of the luminaire including the lamp unit of FIG. 3A and the socket apparatus of FIG. 4A arranged in a line;

FIG. 6A is a cross-sectional view of a luminaire according to a second embodiment;

FIG. 6B is an enlarged cross-sectional view showing a portion A in FIG. 6A;

FIG. 7 is a perspective view of a lamp unit of a luminaire according to a third embodiment;

FIG. 8 is a cross-sectional view of a luminaire according to a fourth embodiment; and

FIG. 9 is an exploded perspective view of the luminaire shown in FIG. 8.

### DETAILED DESCRIPTION

In general, according to one embodiment, there is provided a waterproofed luminaire.

The luminaire according to the one embodiment includes a lamp unit, a socket and a seal member. The lamp unit has a watertight structure, includes a light-emitting portion and a lighting circuit integrated therein, and is formed with a cap in a range where a plug electrically connected to the lighting circuit projects. The socket has a mounting portion for the cap and a terminal provided on the mounting portion. The terminal is electrically connected to the plug when the cap is coupled to the mounting portion. The seal member is attached along an outer peripheral portion of a joint surface between the cap and the mounting portion, and seals a portion between the lamp unit and the socket with a watertight condition.

When making the luminaire in which the filament bulb is employed as a light source waterproof, a globe portion of the filament bulb is generally covered with a transparent cover. Then, a joint portion between an outer shell which constitutes a body of the luminaire and the cover is made waterproof so as to prevent the globe portion of the filament bulb from being subject directly to water such as rain water. It is because the globe portion of the filament bulb is increased in temperature to a level higher than the boiling point of water due to radiation heat emitted by the light source, and hence the globe portion of the filament bulb may be broken by heat shock when being cooled abruptly by water.

The globe portion of the LED lamp is little heated by light emitted from the light source. Therefore, when making the luminaire in which the LED lamp is used as a light source waterproof, the globe portion is not heat-shocked even being subject to water, so that the globe portion is not needed to be covered with the cover. However, electric systems such as a cap portion are needed to be made waterproof. Accordingly, waterproof luminaires which can be installed in bathrooms or as outdoor gate lamps are demanded.

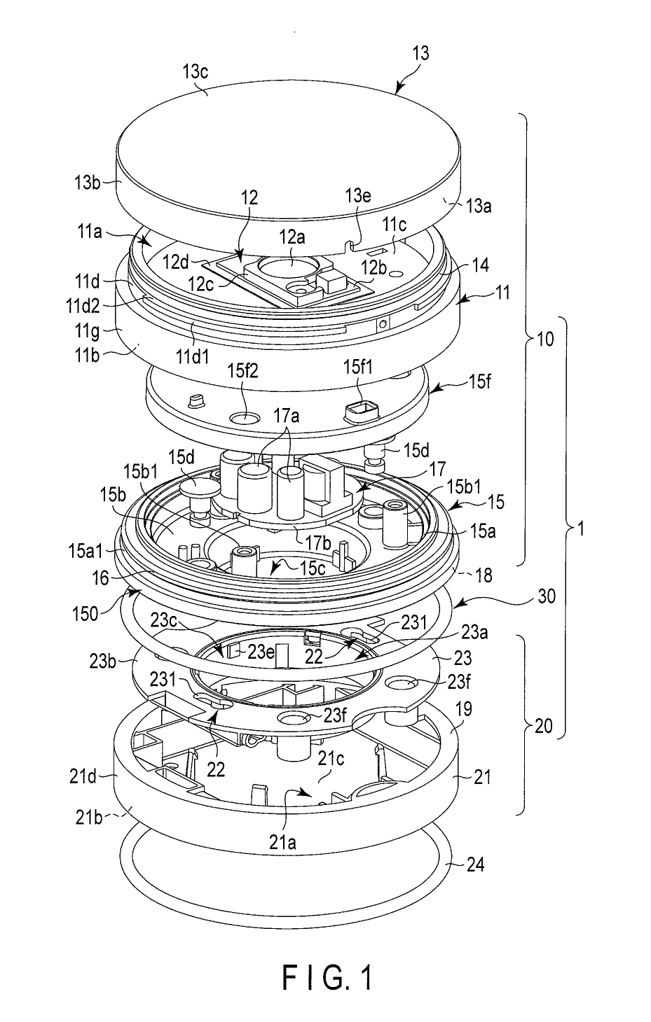

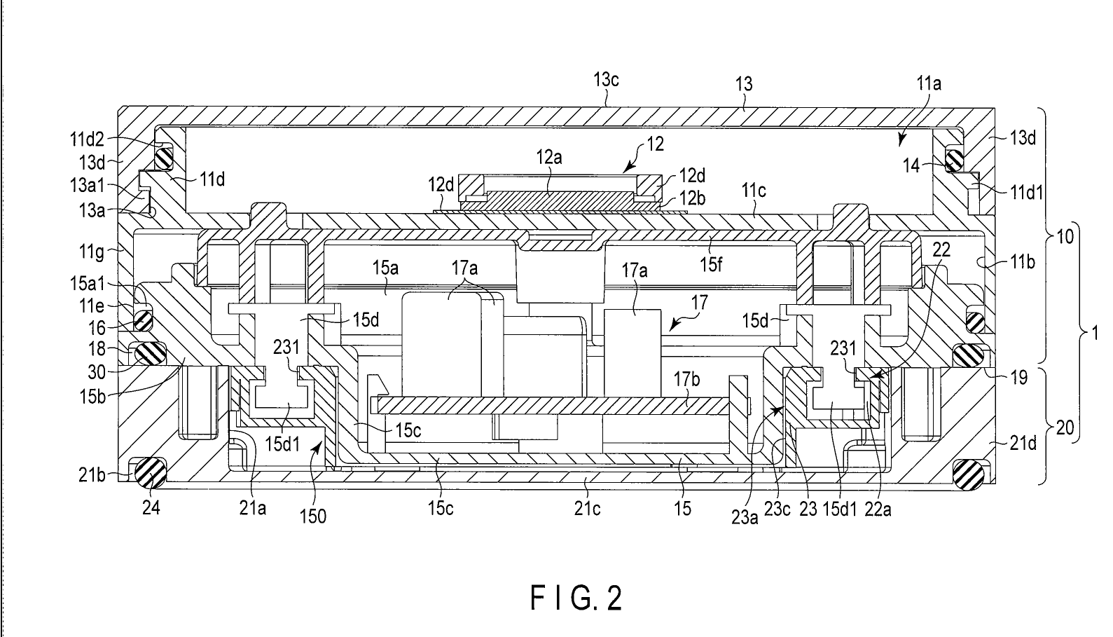

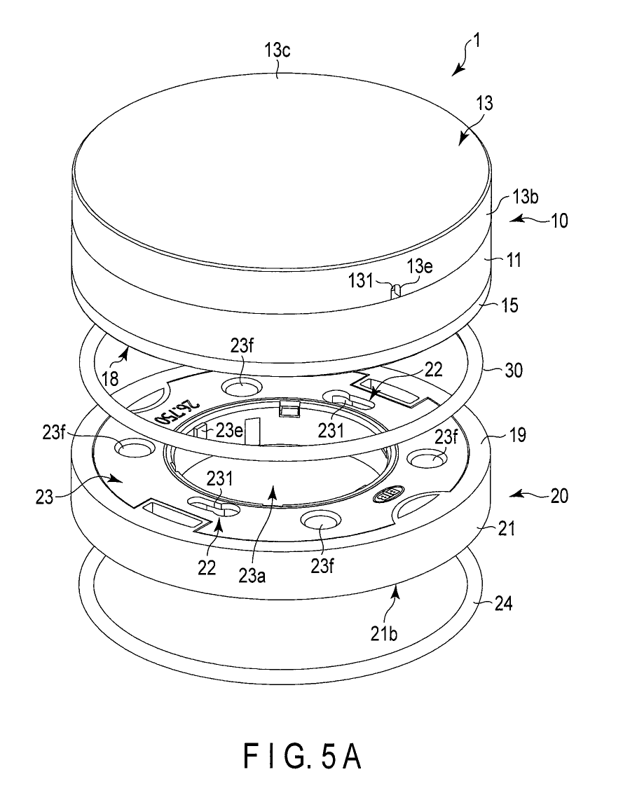

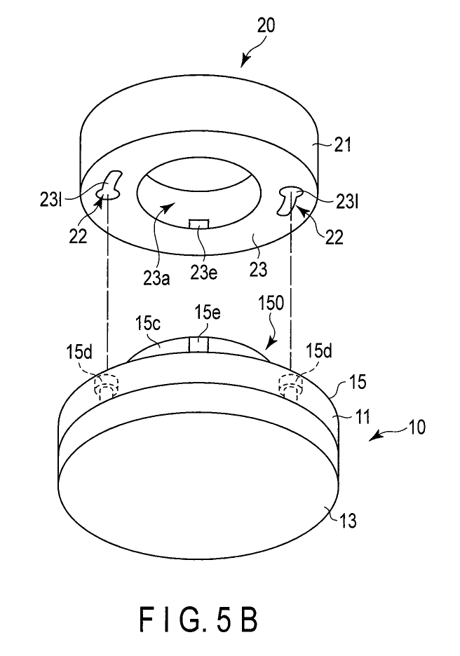

Referring now to FIGS. 1, 2, 3A to 3D, 4A to 4E, and 5A and 5B, a luminaire 1 according to a first embodiment will be described. The luminaire 1 includes a lamp unit 10, a socket 20, and a seal member 30 as shown in FIG. 1, FIG. 2 and FIG. 5A.

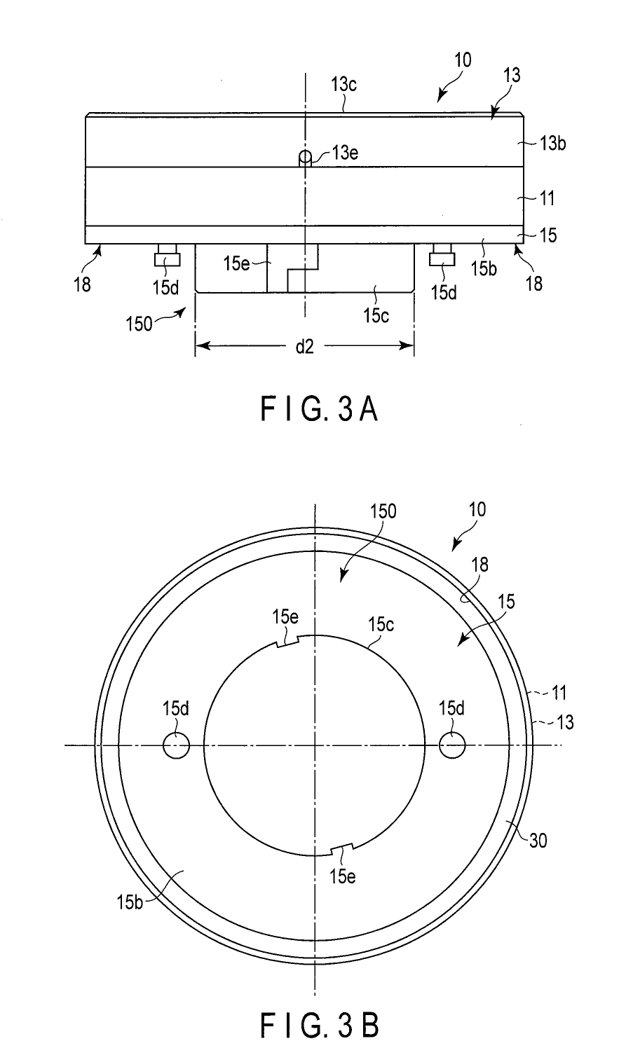

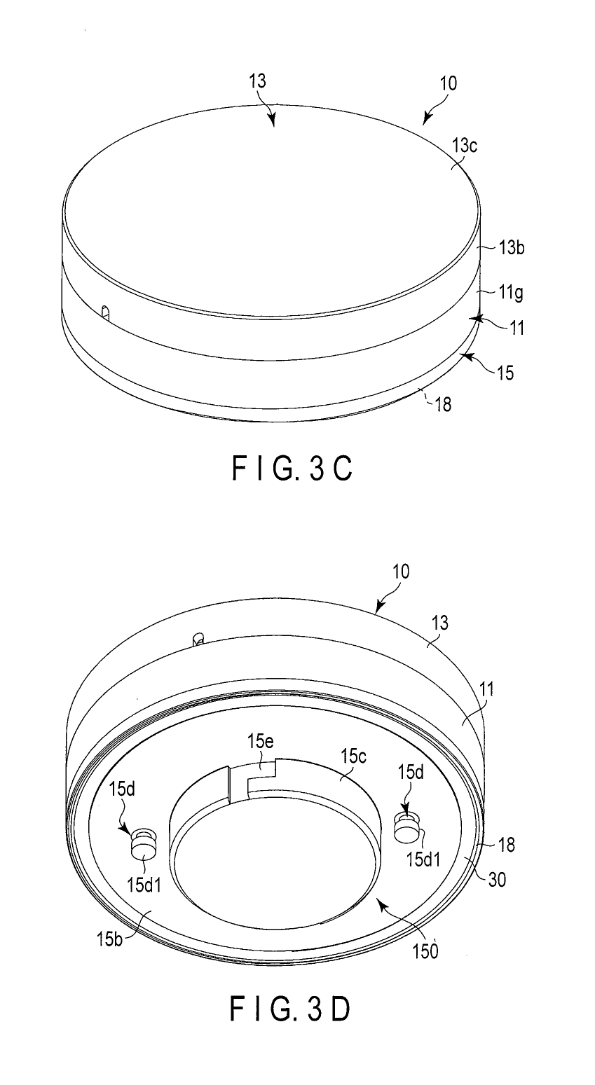

First of all, the lamp unit 10 will be described using FIGS. 1, 2, 3A to 3D. The lamp unit 10 includes a cap 150 of GX53 type in this embodiment. A light emitting surface of the lamp unit 10 is formed into a flat shape as shown in FIG. 2 and FIG. 3A. As shown in FIG. 1, the lamp unit 10 includes a first frame 11, a light-emitting module 12, a globe 13, a globe seal 14, a second frame 15, a plug 15d, a third frame 15f, a frame seal 16, and a lighting circuit 17.

The first frame 11 includes a flat disk-shaped substrate supporting portion 11c, a cylindrical shaped projecting ridge portion 11d, and a cylindrical shaped outer cylinder 11g. The substrate supporting portion 11c is flat enough to be thermally connect with the light-emitting module 12. The light-emitting module 12 is installed at a substantially center portion of the substrate supporting portion 11c. The projecting ridge portion 11d extends from an outer peripheral edge of the substrate supporting portion 11c which surrounds the light-emitting module 12 toward a light-emitting side of the light-emitting module 12 to form an opening 11a. The outer cylinder 11g extends from the outer peripheral edge of the substrate supporting portion 11c toward the side opposite from the projecting ridge portion 11d to form the opening 11b.

The projecting ridge portion 11d is integrally formed with a screw portion 11d1 for assembly of the globe 13, a groove portion 11d2 for holding the globe seal 14 on an outer peripheral surface thereof. The groove portion 11d2 makes a turn over the outer peripheral surface of the projecting ridge portion 11d and an inner surface thereof is a smooth surface which comes into contact with the globe seal 14 in a watertight manner. The outer cylinder 11g has a smooth tight-contact portion 11e which comes into contact with the frame seal 16 in a watertight manner on an inner peripheral surface thereof close to an end portion thereof. The tight-contact portion 11e is formed so as to make one turn along the inner peripheral surface of the outer cylinder 11g.

The first frame 11 having details as described above is formed of a metal having a desirable heat conductivity, in this embodiment, aluminum alloy coated in white on the surface thereof in order to enhance the emissivity. The first frame 11 is manufactured, for example, by diecast or casting, or a combination of diecast or casing and cutting. The outer diameter of the first frame 11, in this embodiment, the outer diameter of the outer cylinder 11g is formed to be substantially the same as the outer diameter of a socket base 21.

The light-emitting module 12 is mounted on the substrate supporting portion 11c in an orientation in which light is emitted from the opening 11a. The light-emitting module 12 includes a light-emitting portion 12a, a substrate 12b, and a holder 12c. The light-emitting portion 12a includes, in this embodiment, a plurality of LED chips. The LED chips having the same performance are employed as the plurality of LED chips. The LED chips employed in this embodiment are LED chips emitting high-intensity, high-output blue light. The light-emitting module 12 includes a number of LED chips mounted on the light-emitting module 12 in Chip On Board (COB) system, and the respective LED chips are covered with a yellow fluorescent material so as to emit white light. In this embodiment, the light-emitting portion 12a may be formed of a single solid semiconductor LED chip.

The substrate 12b of the light-emitting module 12 is electrically insulated with respect to the substrate supporting portion 11c of the first frame 11, and is fastened using the holder 12C and a screw so as to come into tight contact with the flat substrate supporting portion 11c. At this time, an insulating sheet 12d formed of silicone resin or the like is inserted between the substrate supporting portion 11c and the substrate 12b as shown in FIG. 2. Accordingly, the light-emitting module 12 is arranged with the light-emitting portion thereof facing the opening 11a of the first frame 11, and a surface of the light-emitting module 12 on the side opposite from an LED mounted surface is reliably brought into tight contact with the substrate supporting portion 11c. Heat generated from the light-emitting portion 12a is transferred efficiently to the aluminum first frame 11 and is dissipated therefrom. The optical axis of the light-emitting module 12 substantially matches the center axis of the first frame 11. A light-emitting surface of the light-emitting module 12 has a circular shape when viewed along the optical axis as shown in FIG. 1.

The globe 13 is assembled to the projecting ridge portion 11d of the first frame 11 so as to cover the light-emitting module 12 as shown in FIG. 2. The globe 13 is a cover configured to protect the light-emitting module 12, and is formed of a transparent member, or a translucent member having light diffusing properties. In the embodiment, the globe 13 is formed of milky while and translucent polycarbonate resin. The globe 13 includes a cylindrical side wall 13b extending from an outer peripheral edge of a flat disk-shaped light ejecting portion 13c toward the first frame 11. The inner diameter of an opening 13a formed by the side wall 13b has a size fitted to an outer diameter of the projecting ridge portion 11d of the first frame 11. A screw portion 13a1 which matches the screw portion 11d1 of the first frame 11 is formed integrally with an inner peripheral surface of the side wall 13b.

The globe 13 covers the light-emitting module 12 installed on the first frame 11, and is removably fastened by screwing the screw portion 13a1 of the opening 13a into a screw portion lldl of the projecting ridge portion 11d of the first frame 11. The screw portion 11d1 and the screw portion 13a1 are single-threaded screws.

The globe seal 14 is inserted between the first frame 11 and the globe 13 as shown in FIG. 2 so as to achieve tight sealing therebetween. The globe seal 14 is an O-ring and, in this embodiment, is formed of silicone rubber or natural rubber. The globe seal 14 is fitted into the groove portion 11d2 formed on the projecting ridge portion 11d of the first frame 11 in advance. The globe 13 is combined with the projecting ridge portion 11d of the first frame 11, on which the globe seal 14 is assembled. When the globe 13 is screwed into the first frame, the globe seal 14 is oppressed between the inner peripheral surface of the side wall 13b of the globe 13 and the groove portion 11d2 of the first frame 11 to join the globe 13 and the first frame 11 in an airtight manner. The light-emitting module 12 is accommodated in a portion surrounded by the first frame 11 and the globe 13 in an airtight manner, that is, in a waterproof manner.

The globe 13 may be fastened to the first frame 11 with a separately prepared screw or may be combined therewith by a fitting device including a hollow and a projection. The globe 13 may be adhered with an adhesive agent such as a silicone resin or an epoxy resin so as to avoid the globe 13 from coming apart from the first frame 11 after the assembly thereto. Alternatively, the globe 13 may be fusion bonded using laser or ultrasonic wave. If the first frame 11 and the globe 13 are sealed in a watertight manner, the joining means is not specifically limited.

The second frame 15 includes a pair of the plugs 15d projecting toward a side opposite from the side to be combined to the first frame 11 as shown in FIGS. 2 and 3A. The second frame 15 is formed of a synthetic resin superior in heat resistant properties, weather resistant properties, and electrical insulating properties. In the embodiment, the second frame 15 is formed integrally of a white polybutylene terephthalate (PBT) resin. The second frame 15 includes an opening 15a which is fitted to the outer cylinder 11g of the first frame 11, and a supporting portion 15b which comes into abutment with the socket 20. The supporting portion 15b has a cylindrical boss 15c protruding in the direction in which the plugs 15d projects at the center portion thereof.

A pair of the plugs 15d are arranged on the annular supporting portion 15b around the boss 15c at symmetrical position with respect to the boss 15c as shown in FIG. 3B. The plugs 15d supply the light-emitting module 12 with power via the lighting circuit 17. The opening 15a includes a groove 15a1 in which the frame seal 16 is put on an outer peripheral surface thereof as shown in FIGS. 1 and 2. The groove 15a1 is formed so as to make a turn over an outer peripheral surface of the opening 15a, and an inner surface thereof is a smooth surface which comes into contact with the frame seal 16 in a watertight manner. The boss 15c includes a engaging groove 15e, which serves as a coupling device, on an outer peripheral surface of the cylinder as shown in FIGS. 3A and 3D. The engaging groove 15e is used for coupling the lamp unit 10 and the socket 20.

The plugs 15d are conductive members formed of a material such as copper or brass, and are assembled into the supporting portion 15b so as to penetrate therethrough from the inside of the second frame 15 and project toward the socket 20 as shown in FIGS. 1 and 2. The plugs 15d projecting from the supporting portion 15b each has a circular flange-shaped connecting portion 15d1 at a distal end thereof as shown in FIGS. 3A and 3D. The plugs 15d may be embedded integrally when resin-molding the second frame 15.

The third frame 15f is assembled between the first frame 11 and the second frame 15 as shown in FIGS. 1 and 2. The third frame 15f closes the opening 15a of the second frame 15 and is in tight contact with the substrate supporting portion 11c of the first frame 11. The third frame 15f has a cylindrical rib at a position corresponding to the plugs 15d. The rib supports proximal portions of the plugs 15d mounted on the supporting portion 15b from the inside of the lamp unit 10. The third frame 15f is formed of the white PBT resin which is the same as the material of the second frame by injection molding.

As shown in FIGS. 3A and 3D, the supporting portion 15b, the boss 15c and the plugs 15d of the second frame 15 constitute the cap 150 in the lamp unit 10. In the embodiment, the cap 150 is of a GX53 type.

The frame seal 16 is a seal member to be inserted between the first frame 11 and the second frame. In the embodiment, the frame seal 16 is an O-ring molded with silicone rubber or natural rubber. The frame seal 16 is put into the groove 15a1 formed on an outer peripheral surface of the second frame 15 in advance. The opening 15a of the second frame 15 in a state in which the frame seal 16 is put thereon is pushed into the outer cylinder 11g of the first frame 11 against a resilient force of the frame seal 16 and fitted thereon.

The lighting circuit 17 controls the light-emitting module 12 to be turned ON. The lighting circuit 17 is assembled into the interior of the boss 15c of the second frame 15 as shown in FIG. 2. The lighting circuit 17 converts electric power supplied at an AC voltage of 100V into a DC voltage of 24V, and supplies the same to a light-emitting portion 12a as a DC power at a constant current. The lighting circuit 17 includes some circuit parts 17a and a circuit substrate 17b on which the circuit parts 17a are mounted as shown in FIG. 1. The circuit substrate 17b is formed of glass epoxy resin into a disk shape having a size which can be accommodated in the interior of the boss 15c of the second frame 15. The circuit substrate 17b is formed with a circuit pattern on at least one of the surfaces thereof and includes the circuit parts 17a which are a plurality of small electronic components mounted thereon.

In the lighting circuit 17, the circuit substrate 17b is fastened to the interior of the boss 15c in a state in which the circuit parts 17a are positioned on the side of the third frame 15f. After the lighting circuit 17 is accommodated in the second frame 15, the opening 15a of the second frame 15 is closed by the third frame 15f.

An output terminal of the lighting circuit 17 is connected to the substrate 12b of the light-emitting module 12 by a lead wire inserted into a hole of the substrate supporting portion 11c of the first frame 11 and an insertion hole 15f1 formed in the third frame 15f. An input terminal of the lighting circuit 17 is connected to a pair of the plugs 15d by lead wires. The opening 15a of the second frame 15 is fitted to the outer cylinder 11g of the first frame 11 with the intermediary of the frame seal 16 between the first frame 11 and the second frame 15.

The first frame 11 and the second frame 15 are coupled to each other with a screw in a triplet state including the third frame 15f inserted therebetween. The screw is screwed into a joint boss 15b1 of the second frame 15 from the opening 11a side of the first frame 11 through the substrate supporting portion 11c. The joint boss 15b1 is formed on the supporting portion 15b of the second frame 15 and extends toward the first frame 11 as shown in FIG. 1. The third frame 15f includes a hole 15f2 which is fitted onto the joint boss 15b1 as shown in FIG. 1. The third frame 15f is held in a state of being clamped between the substrate supporting portion 11c of the first frame 11 and a distal end portion of the opening 15a of the second frame 15 as shown in FIG. 2.

The frame seal 16 is compressed between the tight-contact portion 11e formed on the inner peripheral surface of the outer cylinder 11g of the first frame 11 and the groove 15a1 of the second frame 15, and the first frame 11 and the second frame 15 are joined in an airtight manner. The lighting circuit 17 and the plugs 15d are made waterproof by being accommodated in a container assembled with the first frame 11 and the second frame 15. The outer cylinder 11g of the first frame 11 and the opening 15a of the second frame 15 may be sealed using adhesive agent such as silicone resin or epoxy resin.

The lamp unit 10 includes a first seal portion 18 which surrounds the boss 15c and the plugs 15d on the cap 150 as shown in FIGS. 2, 3B and 3D. In the embodiment, the first seal portion 18 is a seal groove formed at a position a little inner peripheral side from an outer peripheral edge of the supporting portion 15b of the second frame 15 so as to face the socket 20. The first seal portion 18 opens toward the socket 20 as shown in FIG. 2. The first seal portion 18 is formed along the edge of the supporting portion 15b close to the outer periphery thereof, and an inner surface of the first seal portion 18 is a smooth surface which comes into contact with the seal member 30 in a watertight manner. As shown in FIGS. 2, 3B, and 3D, the seal member 30 configured to seal between the lamp unit 10 and the socket 20 is attached on the first seal portion 18.

As described above, the lamp unit 10 has a light-emitting portion including the light-emitting module 12 covered with the milky white globe 13 and the cap 150 of a GX53 type formed on the side opposite from the light-emitting side, and is configured to be watertight structure. The outer diameter of the lamp unit 10 is configured to be substantially the same as the outer diameter of the socket 20.

Subsequently, the socket 20 will be described with reference to FIGS. 1, 2, 4A to 4E. The socket 20 is a socket 20 on which the lamp unit 10 provided with the cap 150 of GX53 type can be mounted, and constitutes the luminaire 1 with the lamp unit 10 mounted thereon.

The socket 20 includes the socket base 21 and a socket inner 23 as shown in FIGS. 1, 2, and 4D. The socket base 21 includes a flat installation wall 21c and a cylindrical outer peripheral wall 21d extending from an outer peripheral edge of the installation wall 21c toward the lamp unit 10 thereby forming an opening 21a toward the lamp unit 10 as shown in FIGS. 1 and 2. The socket base 21 is formed of a member having superior heat resistant properties, weather resistant properties, and electrical insulation properties sufficient for being used outdoors. In the case of the embodiment, the socket base 21 is formed of a synthetic resin, for example, white PBT resin.

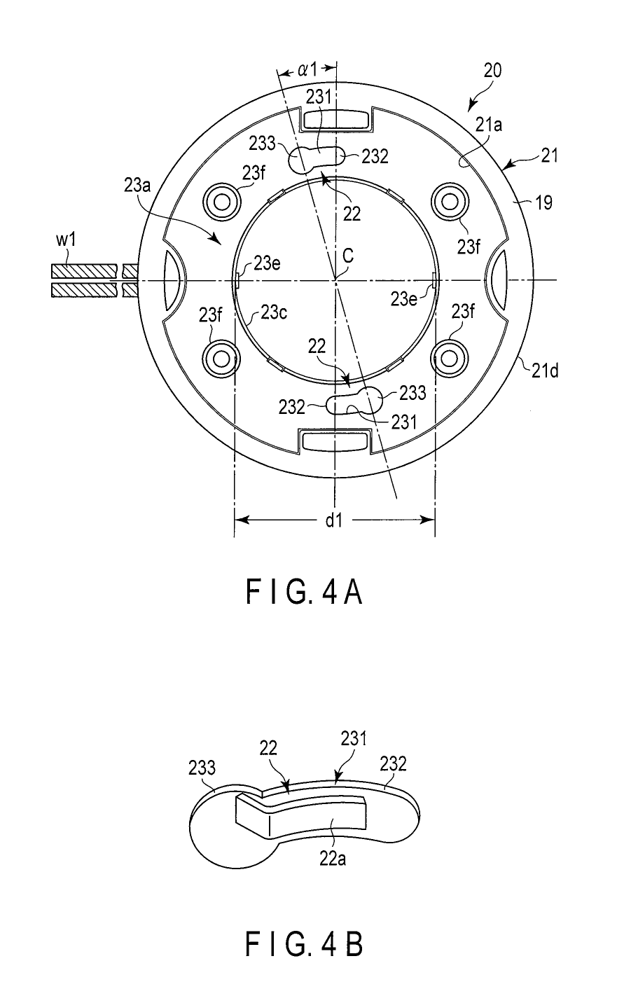

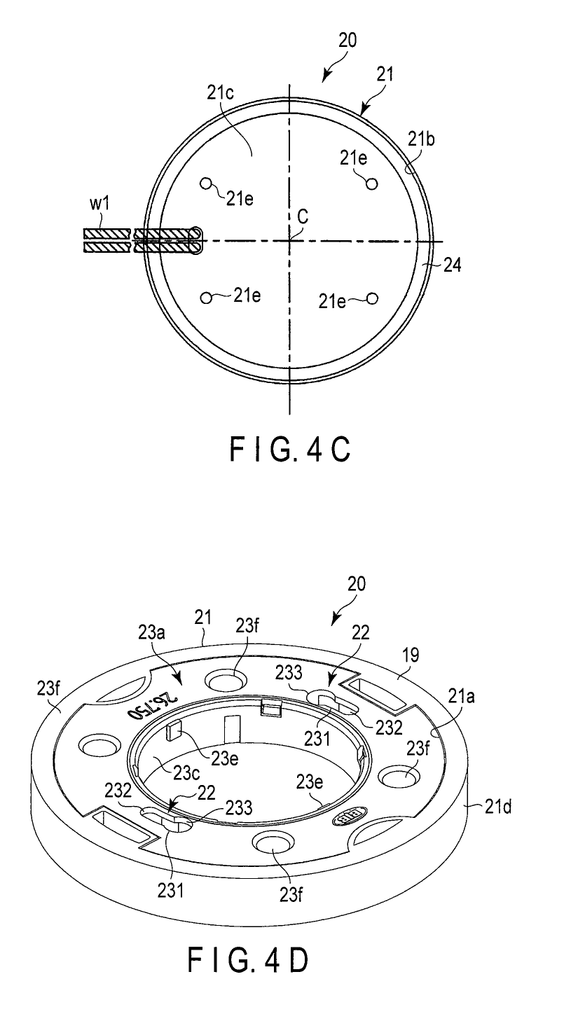

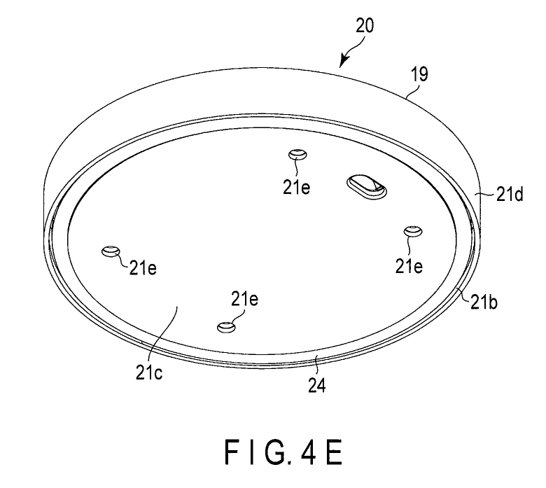

The socket base 21 is formed with an installed seal portion 21b so as to make a turn along an outer peripheral portion of the installation wall 21c corresponding to a range of the thickness of the outer peripheral wall 21d as shown in FIGS. 4C and 4E. The installed seal portion 21b is a seal groove in which a seal member 24 for joining the luminaire 1 to a place of installation in a watertight manner is inserted. The installed seal portion 21b is a smooth surface which comes into contact with the seal member 24 with a watertight condition. In the embodiment, the seal member 24 is an O-ring to be inserted in the installed seal portion 21b, and is formed of silicone rubber or natural rubber. An end of an outer peripheral wall of the socket base 21 faces the first seal portion 18 provided on the second frame 15 of the lamp unit 10, and includes a second seal portion 19. The second seal portion 19 is a smooth surface coming into contact with the seal member 30 which tightly seals between the lamp unit 10 and the socket 20 with a watertight condition.

The socket inner 23 is attached to the opening 21a of the socket base 21 and constitutes a mounting portion 23a which is fitted to the cap 150 of the lamp unit 10 as shown in FIGS. 1 and 2. The socket inner 23 is formed of a synthetic resin superior in electric insulating properties, in this embodiment, of white polycarbonate resin. The socket inner 23 includes a flat ring-shaped flange portion 23b facing the supporting portion 15b of the second frame 15 and an inner cylinder 23c to be fitted on a cylindrical portion of the boss 15c.

The socket inner 23 is mounted on the socket base 21 with the flange portion 23b facing the lamp unit 10 and a distal end of the inner cylinder 23c facing the installation wall 21c of the socket base 21. The socket inner 23 includes an engaging hole on a continuing portion between the flange portion 23b and the inner cylinder 23c. The socket base 21 includes a hook extending from the installation wall 21c and fitting into the engaging hole. When the socket inner 23 is pushed into the opening 21a of the socket base 21, the hook is fitted into the engaging hole, and the socket inner 23 is fastened to the socket base 21.

The flange portion 23b includes connecting holes 231 which allow insertion of the plugs 15d at positions corresponding to the plugs 15d of the lamp unit 10. Connecting members 22 electrically connected to the plugs 15d are arranged in the interior of the socket 20 provided with the connecting holes 231.

The inner cylinder 23c is formed with a hollow which is fitted to the boss 15c. An inner diamter d1 of the inner cylinder 23c shown in FIG. 4A is formed to be slightly larger than an outer diameter d2 of the boss 15c shown in FIG. 3A (d1>d2) so as to allow the fitting of the cap 150 to the mounting portion 23a. The depth of the hollow formed in the inner cylinder 23c of the socket 20 is substantially the same as the height of the boss 15c protruded from the supporting portion 15b of the lamp unit 10.

The inner cylinder 23c has engaging projections 23e to be inserted into the engaging grooves 15e provided on the boss 15c when the cap 150 of the lamp unit 10 is inserted into the mounting portion 23a of the socket 20. When the lamp unit 10 is rotated with respect to the socket 20 so that the engaging projections 23e move along the engaging grooves 15e, the engaging projections 23e are engaged with the engaging grooves 15e. The engaging grooves 15e and the engaging projections 23e are included into an engaging unit for coupling the lamp unit 10 and the socket 20.

The connecting members 22 each includes a terminal plate 22a connected to a commercial power source by a power source line w1. The terminal plates 22a have certain strength and spring properties and are formed of a metal superior in conductivity, for example, copper, brass, or phosphor bronze.

The connecting holes 231 each includes an engaging portion 232, which is an elongated hole extending along an arc centered on the inner cylinder 23c, and an entering portion 233 formed so as to continue to an end of the engaging portion 232. The inner diameter of the entering portion 233 is larger than the outer diameter of the connecting portions 15d1 of the plugs 15d of the lamp unit 10. The width across the engaging portion 232 in the radias direction of the inner cylinder 23c is smaller than the outer diameter of the connecting portion 15d1.

When the connecting portions 15d1 of the plugs 15d inserted from the entering portions 233 move to the engaging portions 232, the connecting portions 15d1 are electrically connected to the terminal plates 22a in the connecting holes 231. At this time, the flange-shaped connecting portions 15d1 are locked by the engaging portions 232 in the direction in which the plugs 15d project, and are mechanically held thereby. The connecting portions 15d1 of the plugs 15d and the connecting holes 231 of the socket inner 23 are included in the engaging unit configured to couple the lamp unit 10 and the socket 20.

In the socket 20, the connecting holes 231 are arranged at positions of point symmetry with respect to a center point C a of the inner cylinder 23c on the ring-shaped flange portion 23b of the socket inner 23 as shown in FIG. 4A.

Subsequently, the seal member 30 will be described with reference to FIGS. 1, 2, 3A, 3D, and 5A. The seal member 30 is an O-ring formed of silicone rubber or natural rubber in the embodiment as shown in FIGS. 1, 2 and 5A. The seal member 30 is mounted along the outer peripheral edge of the joint surface between the cap 150 and the mounting portion 23a, and seals between the lamp unit 10 and the socket 20 in a watertight manner. The seal member 30 is inserted between the first seal portion 18 provided in the lamp unit 10 and the second seal portion 19 provided in the socket 20. The seal member 30 of the embodiment is previously set into the seal groove as an example of the first seal portion 18 formed on the second frame 15 as shown in FIGS. 2 and 3D. The seal member 30 is an O-ring having a larger thichness than the depth of a groove of the first seal portion 18. When the lamp unit 10 is assembled to the socket 20, the seal member 30 is compressed by the first seal portion 18 and the second seal portion 19 and is flattened a little.

The luminaire 1 having the respective members configured as described above will further be described.

The luminaire 1 of the embodiment is installed in places such as outdoors or bathrooms which are directly subject to water. The socket 20 of the luminaire 1 is fastened directly to an installation location with screws or the like inserted from the side of the screw mounting holes 23f formed on the flange portion 23b of the socket inner 23 shown in FIGS. 4A, 4D, and 5A into the installation holes 21e formed on the installation wall 21c of the socket base 21 shown in FIGS. 4C and 4D. The socket 20 is attached the seal member 24 mounted in the installed seal portion 21b provided on the installation wall 21c of the socket base 21 at a position close to the outer periphery thereof.

The seal member 24 is pressed and flattened by an installation location and the installed seal portion 21b when the socket 20 is assembled with screws, and seals between the installation location and the installation wall 21c of the socket base 21. The power source line w1 is wired through routes provided in the installation location separately, which is free from water, on the inner side surrounded by the seal member 24. Since the seal member 24 is attached, ingress of water and dust from the installation holes 21e is prevented.

When coupling the lamp unit 10 to the socket 20 fastened as described above, the connecting portions 15d1 of the plugs 15d and the engaging grooves 15e of the boss 15c are aligned with the entering portions 233 of the connecting holes 231 and the engaging projections 23e of the inner cylinder 23c, and the cap 150 of the lamp unit 10 is joined with the mounting portion 23a of the socket 20 as shown in FIG. 5B. Then, the engaging projections 23e and the plugs 15d are advanced along the engaging grooves 15e and the engaging portions 232, that is, the lamp unit 10 is rotated clockwise by an angle α1 shown in FIG. 4A about a center point C of the inner cylinder 23c of the socket 20. FIG. 5B shows a state in which the luminaire 1 is installed on a ceiling in a bathroom or on a lower surface of something in an outdoor location.

The lamp unit 10 is joined to the socket 20 in a state in which the seal member 30 is held on the first seal portion 18 formed on the supporting portion 15b of the second frame 15 close to the outer periphery thereof as shown in FIG. 3D. The cap 150 is joined to the mounting portion 23a while being pressed against the resilient force of the seal member 30 mounted on the first seal portion 18. The lamp unit 10 is rotated so that the plugs 15d move from the entering portions 233 of the socket inner 23 toward the engaging portions 232. By rotating the lamp unit 10 with respect to the socket 20 in this manner, the lamp unit 10 and the socket 20 are coupled and constitute the luminaire 1.

The connecting portions 15d1 of the plugs 15d come into contact with the terminal plates 22a by being moved from the entering portions 233 to the engaging portions 232, whereby electrical connection is completed. When a pair of the plugs 15d provided on the cap 150 of GX53 type of the lamp unit 10 is connected to the terminal plates 22a of the connecting member 22 of the socket 20, the lamp unit 10 supplied the commercial power. At this time, the connecting portions 15d1 are locked by the engaging portions 232 and are mechanically held thereby. Also, the engaging projections 23e of the socket 20 engage the engaging grooves 15e of the lamp unit 10 and the lamp unit 10 is connected so as not to come apart from the socket 20 easily.

The seal member 30 is compressed between the first seal portion 18 of the second frame 15 and the second seal portion 19 of the socket base 21, so that the waterproof properties are ensured. An electrically connected portion between the plugs 15d and the connecting member 22 included in the joint portion between the lamp unit 10 and the socket 20 is sealed in a watertight manner. When the lamp unit 10 is removed from the socket 20, the lamp unit 10 is rotated in the direction opposite from the direction rotated when the lamp unit 10 is coupled to the socket 20.

The seal member 30 is inserted between the first seal portion 18 and the second seal portion 19 opposing in the direction in which the lamp unit 10 and the socket 20 are arranged. Therefore, it is not necessary to increase the outer diameter of the luminaire 1 for providing a sealing mechanism. In other words, the luminaire 1 can be reduced in size.

The cap 150 and the mounting portion 23a of the luminaire 1 are made waterproof by coupling the lamp unit 10 and the socket 20. The luminaire 1 includes the lamp unit 10, the socket 20 and the seal member 30, and no waterproof case which covers the outside of the lamp unit 10 and the socket 20. In the luminaire 1, the socket 20 is prebuilt on a wall of a bathroom or the like. The terminal plates 22a of the socket 20 are connected to the commercial power source via the power source lines w1. When the lamp unit 10 is joined to the socket 20, the terminal plates 22a and the plugs 15d are connected and power is supplied to the light-emitting module 12 via the lighting circuit 17 of the lamp unit 10. The luminaire 1 illuminates the bathroom by white light emitted from the light-emitting module 12.

According to the luminaire 1 of the embodiment, the cap 150 of the lamp unit 10 and the mounting portion 23a of the socket 20 are made waterproof by the seal member 30 mounted so as to surround the cap 150 and the mounting portion 23a. Therefore, the luminaire 1 may be placed in an environment in which the luminaire 1 is directly subject to water such as outdoors or in the bathroom without providing a waterproof cover separately.

In the luminaire 1 of the embodiment, the outer shells of the lamp unit 10 and the socket 20 are composed of a plurality of parts, and the seal member is attached between the parts which constitute the outer shells, thereby achieving waterproof. The light-emitting module 12 is made waterproof by the globe seal 14 built in between the first frame 11 and the globe 13, and the electronic components or the like of the lighting circuit 17 are made waterproof by the frame seal 16 built in between the first frame 11 and the second frame 15. Furthermore, the power source line w1 drawn into the socket 20 or the locating surface of the luminaire 1 is made waterproof by the seal member 24 built in between the location where the luminaire 1 is installed and the socket base 21.

In the respective drawings in conjunction with second and third embodiments described below, configurations having the same functions as those of the luminaire 1 of the first embodiment are designated by the same reference numerals, and the detailed description thereof are diverted from the description in the first embodiment.

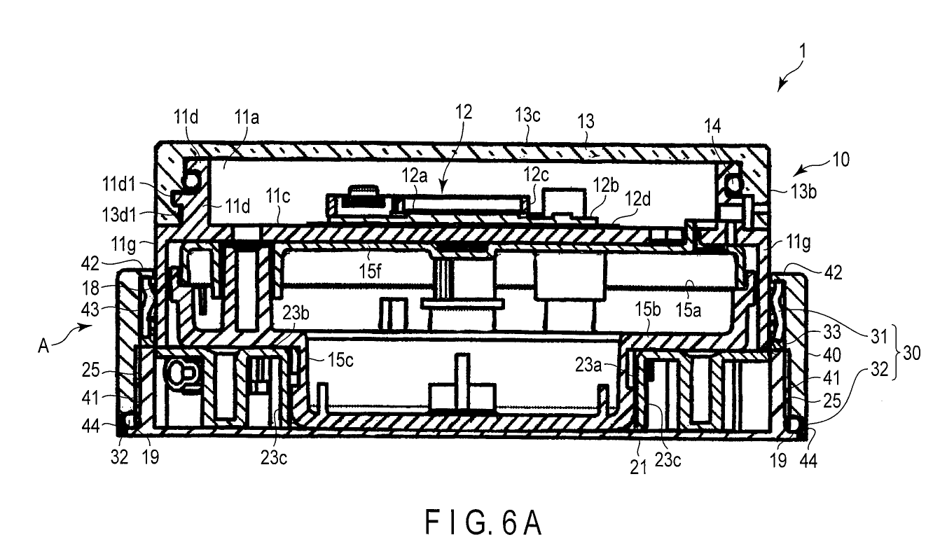

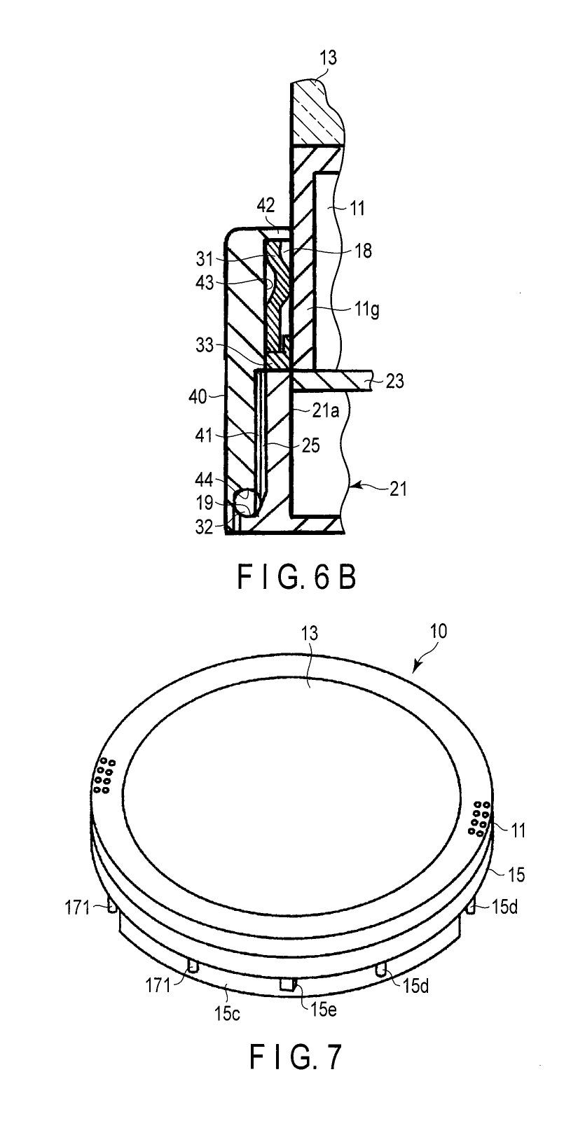

Referring now to FIGS. 6A and 6B, the luminaire 1 of the second embodiment will be described. The luminaire 1 includes an outer ring 40 as shown in FIG. 6A. The outer ring 40 is mounted on the outer periphery of the lamp unit 10 and the socket 20 including a range where the first seal portion 18 and the second seal portion 19 are formed. In this embodiment, the outer ring 40 is coupled to the side of the socket 20. The socket 20 includes a screw portion 25 on the outer peripheral wall 21d of the socket base 21 close to the bottom wall, and the outer ring 40 includes a screw portion 41 at an end thereof close to the socket 20.

In this embodiment, as shown in FIG. 6A, the outer cylinder 11g of the first frame 11 extends to the outer periphery of the supporting portion 15b of the second frame 15. The first seal portion 18 is provided on an outer periphery of the cap 150 facing the outer ring 40, in this embodiment, on an outer peripheral surface of the outer cylinder 11g of the first frame 11 facing the outer ring 40. The second seal portion 19 is provided on an outer peripheral surface of the socket base 21 facing between a range of the outer ring 40 where the screw portion 41 is formed and an end portion.

The outer ring 40 includes a hook 42 at an end thereof close to the lamp unit 10, a third seal portion 43 facing the first seal portion 18, and a fourth seal portion 44 facing the second seal portion 19. The outer ring 40 is formed of white PBT resin in the same manner as the socket base 21. The outer diameter of the outer cylinder 11g of the first frame 11 is smaller than the outer diameter of the outer peripheral wall of the socket base 21.

The seal member 30 includes a first seal member 31 inserted between the first seal portion 18 and the third seal portion 43, and a second seal member 32 inserted between the second seal portion 19 and the fourth seal portion 44. A support ring 33 formed of a material having a small coefficient of friction is attached between the first seal member 31 and the end of the outer peripheral wall of the socket base 21. The first seal member 31 and the second seal member 32 are formed of silicone rubber or natural rubber, and the support ring 33 is formed of synthetic resin such as PBT or hard rubber or the like.

The luminaire 1 according to the second embodiment configured as described above is mounted by coupling the cap 150 of the lamp unit 10 to the mounting portion 23a of the socket 20, and then mounting the outer ring 40 in which the first seal member 31 and the support ring 33 are built in on the socket 20 from the side of the lamp unit 10. The second seal member 32 is attached to the fourth seal portion 44 of the socket 20. As shown in FIG. 6B, when the screw portion 41 of the outer ring 40 is coupled to the screw portion 25 of the socket base 21, the first seal member 31 is compressed between the hook 42 and the end of the outer peripheral wall of the socket base 21, and seals between the first seal portion 18 and the third seal portion 43.

In the case of the second embodiment, the first seal member 31 is a band hoop having a width along the direction in which the outer ring 40 is assembled. As shown in FIG. 6B, when the first seal member 31 is compressed by the support ring 33 having an L-shaped cross section and the hook 42 of the outer ring 40, the first seal member 31 seals between the lamp unit 10 and the outer ring 40 by being bent at a midsection into a wavy shape. The second seal member 32 is compressed by the second seal portion 19 and the fourth seal portion 44, and seals between the second seal portion 19 and the fourth seal portion 44.

Accordingly, the electrically connected portion between the lamp unit 10 and the socket 20 is made waterproof by the seal member 30 including the first seal member 31 and the second seal member 32. At this time, a portion between the first frame 11 and the second frame 15 of the lamp unit 10 is also made waterproof. In other words, the electronic components such as lighting circuit 17 are made waterproof by the seal member 30. In the second embodiment, the frame seal 16 is omitted, and the lamp unit 10 which is advantageous in terms of cost is provided.

In the luminaire 1 in the first embodiment, the electrically connected portion between the lamp unit 10 and the socket 20 is directly sealed by the seal member 30 fitted between the first seal portion 18 of the second frame 15 and the second seal portion 19 provided on the end surface of the outer peripheral wall of the socket base 21. In contrast, in the luminaire 1 of the second embodiment, the electrically connected portion between the lamp unit 10 and the socket 20 is indirectly sealed at a range between the first seal portion 18 and the second seal portion 19 via the outer ring 40.

In the case of the second embodiment, when the outer ring 40 is screwed into the socket base 21, the second seal member 32 is compressed. Ingress of water or dust into a gap between the screw portions 25 and 41 can be prevented. The first seal member 31 is deformed into a wavy shape and a repulsive force (frictional force) holds the first frame 11. In other words, the first seal member 31 constraints the lamp unit 10 from moving with respect to the socket 20. The safety luminaire 1 which prevents the lamp unit 10 from unintentionally coming apart from the socket 20 is provided. The device configured to fasten the outer ring 40 to the socket base 21 is not limited to the screw structure. For example, screws or an adhesive agent prepared separately may be used or, alternatively, a engaging or a hook may be used for fitting the outer ring 40 to the socket base 21.

In the second embodiment, the lamp unit 10 has a flat structure. However, as regards the shape of the lamp unit 10, a lamp with a cap having a shape closely analogous to the shape of general filament lamps (A-type or PS-type), a lamp with a cap having a ball shape (G-type), a lamp with a cap having a cylindrical shape (T-type), and a lamp with a cap having a reflecting mirror integrated therein (R-type) are also applicable. In addition to the shapes described above, exemplary embodiments described above may also be applied to lamps with a cap having other various appearances or for various applications.

The first frame 11 is preferably formed of a metal superior in heat conductivity, for example, a metallic material containing at least one of aluminum (Al), copper (Cu), iron (Fe) and Nickel (Ni) because of the necessity of dissipation of heat from the light-emitting module 12 and the lighting circuit 17. In addition to the metals described above, industrial materials including ceramics formed of aluminum nitride (AlN) and silicon carbide (SiC) are also applicable. Furthermore, the first frame 11 may be formed of a synthetic resin such as high-heat-conductivity resin. Preferably, when configuring the lamp unit 10 having a flat structure, the appearance shape is substantially a disk shape. The outside shape of the lamp unit 10 may be polygonal shapes such as triangle, square, or hexagon, or may be an oval shape.

In order to enhance the heat dissipating properties, heat dissipating members such as a number of heat-dissipating fins or heat-dissipating pins may be integrally formed on an outer peripheral surface of the first frame 11 in a radial pattern. An outer surface of the first frame 11 may be enhanced in thermal emissivity, for example, by forming the surface with dimples and embosses or satin finished surface to increase the surface area, or by applying white coating or white anodizing. When applying the white coating or white anodizing to the lamp unit 10, the reflectivity of the outer surface of the lamp unit 10 exposed to the outside is increased. Since the appearance and the design are improved in addition to the enhancement of the light-emitting efficiency of the luminaire 1, the added value of the products is increased.

The first frame 11 is preferably formed by die-casting aluminum. The first frame 11 may be formed by drawing a metallic plate or roller-forming a ring blank such as an aluminum. In terms of the appearance of the luminaire 1, preferably, the outer diameter of the first frame 11 is substantially the same as the outer diameter of the socket base 21. However, the outer diameter of the first frame 11 may be different from the outer diameter of the socket base 21.

The light-emitting module 12 includes light-emitting elements having a light-emitting diode, a semiconductor laser, or an organic EL as the light source. The light-emitting module 12 may be formed of a discharge lamp generating less heat such as a fluorescent lamp having a light-emitting arc tube meandering along a plane. Although the light-emitting module 12 is preferably configured to emit white light, red, blue, green or combinations of the respective colors may be applicable depending on the application of the luminaire 1. In addition to the circular shape shown in the embodiments, the shape of the light-emitting portion may be polygonal shapes such as triangle, square, and hexagon, or even be a plan module formed into an oval shape, so that all the shapes are allowed as long as the intended light-distribution properties are obtained.

Referring now to FIG. 7, the luminaire 1 according to the third embodiment will be described. In the luminaire 1 shown in FIG. 7, the lighting circuit 17 is configured to allow light control and color control to be performed. The lamp unit 10 of the luminaire 1 in the third embodiment is a relatively large-type lamp unit 10, and has a pair of light control pins 171 as shown in FIG. 7. The socket 20 includes a light control electrode. With the combination of the light control pins 171 and the light control electrode, the luminaire 1 with a light control function is provided.

When being provided with a color control function, a warm white LED or daylight LED are built in as a light-emitting element of the light-emitting module 12. The hue is changed by switching the LEDs built therein. The lighting circuit 17 includes the lamp unit 10 integrated therein. The lighting circuit may be provided on the socket 20 where the lamp unit 10 is to be mounted like a compact-type fluorescent lamp.

The luminaire 1 in the respective embodiments includes the lamp unit 10 and the socket 20. For example, like a downlight, the luminaire 1 may be formed by building the socket 20 into a part of a housing or a reflector designed specifically therefor, and mounting the lamp unit 10 to the socket 20.

The socket base 21 described above is formed of a synthetic resin. In order to dissipate heat of the light-emitting portion or the lighting circuit, the socket base 21 may be formed of a metal superior in heat conductivity, for example, a metallic material containing at least one of aluminum (Al), copper (Cu), iron (Fe), and nickel (Ni) or industrial materials such as ceramics formed of aluminum nitride (A1N) or the like or silicon carbide (SiC). In order to mount the flat lamp unit 10, the shape of the appearance may be a polygonal shape such as triangle, square, or hexagon, or an oval shape or the like instead of being substantially the disk shape.

The luminaire 1 is employed in various types such as a ceiling-embedded type, a direct-installed type, a pending type, and a wall-surface-attached type. The luminaire 1 may further be provided with a shade, a reflector, or a light-distributing plate as a light reducing member, or the lamp unit 10 may be exposed. The socket 20 of the luminaire 1 is not limited to a configuration which allows attachment of a single lamp unit 10, but may be configured to allow attachment of a plurality of the lamp units 10. The large luminaire 1 having a plurality of the lamp units 10 mounted thereon may be employed in offices or in commercial facilities.

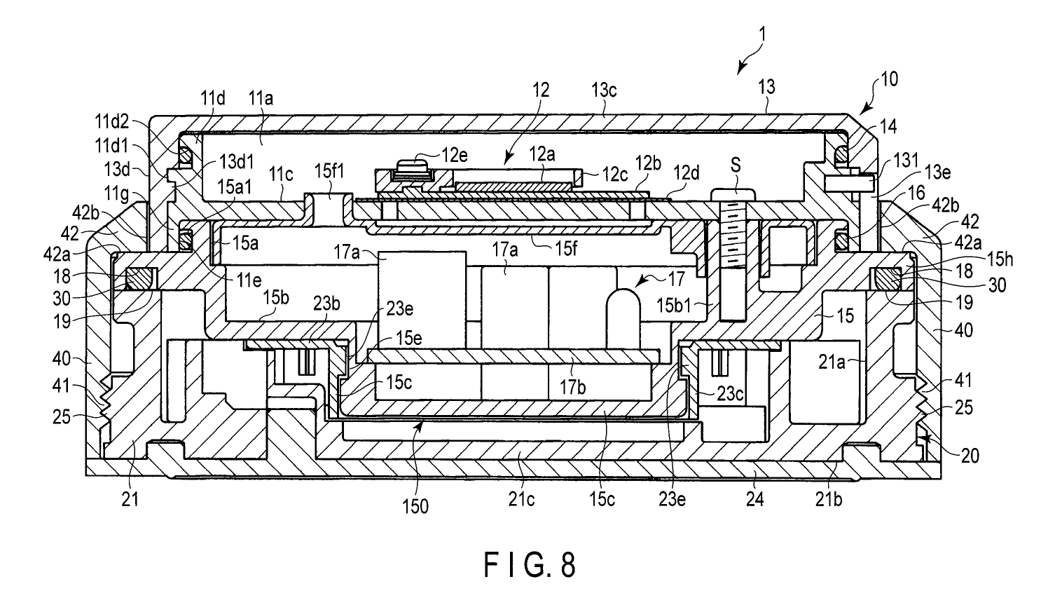

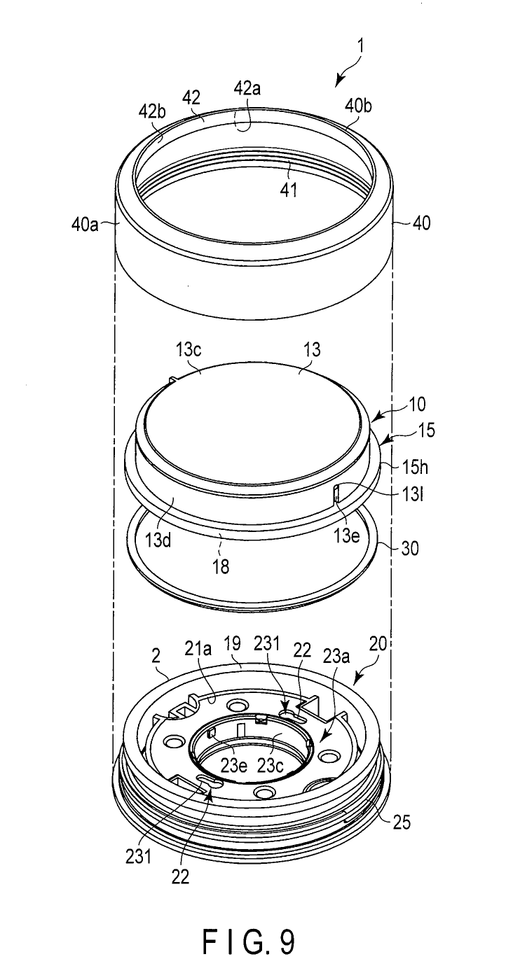

Referring now to FIGS. 8 and 9, the luminaire 1 according to a fourth embodiment will be described. The luminaire 1 is used in an environment, for example, in which the luminaire 1 is subject to water such as outdoors like in the first to the third embodiments, and has a waterproof structure.

The luminaire 1 is provided with the lamp unit 10, the socket 20, the seal member 30, and the outer ring 40. The lamp unit 10 is formed into a flat shape. The socket 20 allows attachment of the lamp unit 10 of the fourth embodiment. The seal member 30 is mounted between the lamp unit 10 and the socket 20. The outer ring 40 flattens the seal member 30 by pressing the lamp unit 10 against the socket 20, and improves the waterproof properties between the lamp unit 10 and the socket 20. In the description given below, a side where the lamp unit 10 emits light may be referred to as a “front” and the other side opposite therefrom as a “back”.

The lamp unit 10 includes the first frame 11, the light-emitting module 12, the globe 13, the second frame 15, and the lighting circuit 17. The first frame 11 allows attachment of the light-emitting module 12. The globe 13 is attached to the first frame 11 so as to cover the light-emitting module 12. The second frame 15 is attached to the back surface of the first frame 11. The lighting circuit 17 is accommodated in the interior surrounded by the first frame 11 and the second frame 15.

The light-emitting module 12 includes the light-emitting portion 12a, the substrate 12b, and the holder 12c. The substrate 12b is formed of metal, or of ceramic, for example. The light-emitting portion 12a is a surface light source, and is formed on the substrate 12b. The light-emitting portion 12a is configured of a semiconductor light-emitting element such as an LED element or an EL element, for example, as a light source. In this embodiment, the LED element is used as the semiconductor light-emitting element. The light-emitting portion 12a of Chip On Board (COB) type that the plurality of LED elements mounted on the substrate 12b are integrally covered with a fluorescent layer is employed. As the light-emitting portion 12a, a plurality of Surface Mount Device (SMD) packages on which a high-output LED element is mounted may be mounted on the substrate 12b. The holder 12c has insulating properties, and is attached to the substrate 12b. The insulating sheet 12d superior in heat conductivity is interposed between the substrate 12b and the first frame 11. The substrate 12b is attached to the first frame 11 by a plurality of screws 12e inserted through the holder 12c. Since the substrate 12b is thermally connected to the first frame 11, heat generated by the LED element is efficiently transferred to the first frame 11.

The first frame 11 is integrally formed of a metallic material or an insulating material such as synthetic resins, and includes the disk-shaped substrate supporting portion 11c, the projecting ridge portion 11d and the outer cylinder 11g provided in the periphery of the substrate supporting portion 11c. The light-emitting module 12 is attached to the front surface of the substrate supporting portion 11c. The projecting ridge portion 11d projects from the substrate supporting portion 11c toward the front side and the outer cylinder 11g projects toward the back side. The projecting ridge portion 11d has a plurality of projections 11d1 configured to couple the globe 13 at a plurality of positions on the outer periphery thereof, and has the annular groove portion 11d2 configured to mount the annular globe seal 14 interposed between the projecting ridge portion 11d and the globe 13 on the outer peripheral surface thereof close to a distal end portion thereof.

The second frame 15 is provided with the cap 150 mounted on the socket 20 and, for example, is formed integrally of an insulating material such as a synthetic resin. The cap 150 is a cap of GX53 type, for example and is formed on the back side of the second frame 15, and the interior of the cap 150 is opened toward the side of the first frame 11. The cylindrical boss 15c is integrally formed at a center of the cap 150 on the back side, and a pair of plugs are arranged in the periphery of the cap 150 on the back side. The boss 15c includes a plurality of L-shaped engaging grooves 15e used to be mounted on the socket 20 on the outer peripheral surface thereof.

The second frame 15 includes a peripheral wall 15a on the front side to be fitted into the inner periphery of the outer cylinder 11g of the first frame 11, and the annular groove 15a1 is formed on an outer peripheral surface of the peripheral wall 15a. The annular frame seal 16, which is interposed between the second frame 15 and the first frame 11, is attached into the annular groove 15a1. The second frame 15 is coupled to the first frame 11 by a plurality of screws S inserted from the first frame 11 side in a state in which the peripheral wall 15a is fitted into the first frame 11.

The lamp unit 10 includes an annular flange 15h on the outer side surface of the second frame 15, which corresponds to an outer peripheral portion thereof. The flange 15h includes the first seal portion 18, which is an annular seal groove, on the back surface facing the socket 20. The seal member 30 is an O-ring, and is set into the first seal portion 18.

The globe 13 is formed integrally using a translucent insulating material such a synthetic resin or the like, and includes the disk-shaped light ejecting portion 13c and a peripheral wall 13d as shown in FIG. 8. The light ejecting portion 13c is arranged so as to cover the front side of the first frame 11, that is, the light-emitting module 12 which is a light-emitting portion. The peripheral wall 13d is formed so as to surround the projecting ridge portion 11d and the outer cylinder 11g of the first frame 11. The peripheral wall 13d includes a plurality of projections 13d1 configured to engage the projections 11d1 of the first frame 11. The projections 13d1 of the globe 13 engage the projections 11d1 of the first frame 11, whereby the first frame 11 and the globe 13 are coupled. The globe 13 includes a slit 13e where a pin 131 is inserted at one position of the peripheral wall 13d. The pin 131 serves to prevent the globe 13 from rotating with respect to the first frame 11 by being inserted through a slit 48 to the first frame 11 in order to maintain a state in which the projections 13d1 of the globe 13 and the projections 11d1 of the first frame 11 are engaged.

The peripheral wall 13d of the globe 13 is configured as part of a housing which forms the outer peripheral portion of the lamp unit 10, and the annular flange 15h projects from the outer peripheral surface of the housing. The outer side surface of the housing opposing the flange 15h, that is, the peripheral wall 13d of the globe 13 is formed of at least an insulating material, and the outer side surface of the housing on the light-emitting side with respect to the flange 15h is formed of an insulating material. In this embodiment, the entire part of the globe 13 and the second frame 15 which constitute the housing is formed of the insulating material.

The lighting circuit 17 is provided with a plurality of the circuit parts 17a which constitute a circuit mounted on at least one surface of the circuit substrate 17b. The lighting circuit 17 is accommodated in a space defined in the interior of the cap 150 which corresponds to a space between the first frame 11 and the second frame 15, and is fastened to the second frame 15. The back surface of the first frame 11 facing the lighting circuit 17 is covered with the third frame 15f formed of an insulating material such as a synthetic resin. An input portion of the lighting circuit 17 is electrically connected to a pair of the plugs 15d, and an output portion is electrically connected to the LED element of the light-emitting module 12. The lighting circuit 17 includes a power source circuit which converts a commercial AC current to a DC power, a DC/DC converter configured to convert the DC power to a predetermined DC output by a switching element, supply the DC power at the predetermined DC output to the LED element, and turn the light-emitting module 120N, and an integrated circuit configured to control the oscillation of the switching element.

The socket 20 includes the socket inner 23 on which the cap 150 of the lamp unit 10 is mounted, and the socket base 21 in which the socket inner 23 is to be built in. The socket inner 23 includes a shape corresponding to the GX53-type cap, for example, and is integrally formed of an insulating material such as a synthetic resin. The socket inner 23 includes the inner cylinder 23c which allows insertion of the boss 15c of the cap 150 at a center portion thereof. The inner cylinder 23c includes a plurality of the engaging projections 23e projecting from the inner peripheral portion. The engaging projections 23e are rotatably mounted to the plurality of L-shaped engaging grooves 15e formed on the outer peripheral portion of the boss 15c. The socket inner 23 includes a pair of the connecting holes 231 to be connected to a pair of the plugs 15d (see the first embodiment) on the flange portion 23b. The socket 20 includes the connecting member 22 (see the first embodiment) to which the plugs 15d are electrically connected arranged on the inner side of the connecting holes 231.

The socket base 21 is integrally formed by the insulating material such as a synthetic resin, and includes the disk-shaped installation wall 21c and the outer peripheral wall 21d provided in the periphery of the installation wall 21c. The socket inner 23 is attached on the front side of the installation wall 21c, and is surrounded by the outer peripheral wall 21d of the socket base 21 in the periphery thereof. The installation wall 21c includes the disk-shaped seal member 24 attached on the back side thereof. The power source line w1 is penetrated through the seal member 24 arranged in the socket 20, and is electrically connected to the connecting member 22.

The outer diameter of the outer peripheral wall 21d is formed to be substantially the same as the outer diameter of the flange 15h of the lamp unit 10. The outer peripheral wall 21d includes the annular second seal portion 19 with which the flange 15h of the lamp unit 10 comes into tight contact with the intermediary of the seal member 30 on the front surface thereof. The outer peripheral wall 21d includes a male screw portion 25 as a socket side mounting portion to which the outer ring 40 is mounted along the outer peripheral surface close to the installation wall 21c.

The socket inner 23 may be a member separate from the socket base 21, and may be provided on the socket base 21 so as to be movable in the fore-and-aft direction (the direction of mounting the lamp unit 10). In this case, the socket 20 is configured in such a manner that the socket inner 23 moves toward the cap 150 against an urging force of a spring, and the lamp unit 10 is attracted toward the socket 20 side by the urging force of the spring by coupling the cap 150 of the lamp unit 10 to the mounting portion 23a of the socket inner 23. The lamp unit 10 and the socket 20 are brought into tight contact with each other, and the waterproof performance and a heat dissipating performance are improved.

The outer ring 40 includes a cylindrical side wall 40a formed of a metallic material into a cylindrical shape, and configured to fit on the flange 15h of the lamp unit 10 and the outer peripheral portion of the socket 20. The outer ring 40 has an opening 40b which allows passage of the globe 13 of the lamp unit 10 therethrough on the side of the lamp unit 10. The side wall 40a includes a female screw portion 41 which is a coupling portion with respect to the socket 20 and the hook 42 which is an engaging portion with respect to the flange 15h of the lamp unit 10. The female screw portion 41 is formed on an inner peripheral surface of the side wall 40a of the outer ring 40 close to the installation wall 21c of the socket base 21, and is fitted onto the male screw portion 25 of the socket 20. The hook 42 is formed at an end portion of the side wall 40a on the side of the lamp unit 10, and engages the front side of the flange 15h of the lamp unit 10 mounted on the socket 20. The hook 42 includes an abutment surface 42a which comes into abutment with a front surface of the flange 15h, and an inner peripheral surface 42b opposing the peripheral wall 13d of the globe 13 at a distance.

Subsequently, an operation of the luminaire 1 of the fourth embodiment will be described. The lamp unit 10 includes the first frame 11 and the second frame 15 sealed by the frame seal 16, and the first frame 11 and the globe 13 sealed by the globe seal 14. Therefore, the housing of the lamp unit 10 made up of the first frame 11 and the second frame 15 and the globe 13 has a waterproof structure. The socket 20 is fastened to the surface of installation, for example, such as an outdoor wall surface or a ceiling surface, by inserting the seal member 24 and tightening screws. When installing the socket 20, the power source line w1 is wired in the socket 20.

The cap 150 of the lamp unit 10 is fitted into the mounting portion 23a of the socket 20, and the engaging grooves 15e of the cap 150 are fitted on the engaging projections 23e of the socket inner 23. At this time, the plugs 15d are inserted into the connecting holes 231. The seal member 30 is clamped between the first seal portion 18 of the flange 15h and the second seal portion 19 of the socket base 21 by fitting the cap 150 of the lamp unit 10 into the mounting portion 23a.

The cap 150 is fitted into the mounting portion 23a, the flange 15h having the seal member 30 mounted in the first seal portion 18 is pressed against the second seal portion 19 of the socket base 21, and the lamp unit 10 is rotated by a predetermined angle. The engaging grooves 15e of the cap 150 engage the engaging projections 23e of the socket inner 23 and the lamp unit 10 is coupled to the socket 20. The plugs 15d are electrically connected to the terminal plates 22a of the connecting members 22 arranged inside the connecting holes 231. At this time, when the socket inner 23 is provided so as to be movable in the fore-and-aft direction with respect to the socket base 21 (the direction of mounting and demounting the lamp unit 10) as described above, if the cap 150 is attached to the mounting portion 23a, the socket inner 23 is moved toward the cap 150 against the urging force of the spring. Consequently, the lamp unit 10 is attracted toward the socket 20 by the urging force of the spring.

In this manner, only by attaching the lamp unit 10 to the socket 20, the portion between the first seal portion 18 of the lamp unit 10 and the second seal portion 19 of the socket 20 is sealed by the flattened seal member 30, and the electrically connected portion of the luminaire 1 is made waterproof.

In the luminaire 1 of the fourth embodiment, the outer ring 40 is mounted from the lamp unit 10 side to couple the female screw portion 41 to the male screw portion 25 of the socket base 21. The hook 42 of the outer ring 40 engages the flange 15h as the female screw portion 41 is screwed into the male screw portion 25. The flange 15h presses the seal member 30 against the second seal portion 19 of the socket base 21 and flattens at the same time, and is brought into tight contact therewith. When the flange 15h is brought into abutment with the second seal portion 19 of the socket base 21, the tightening of the outer ring 40 is restricted. In this state, the lamp unit 10, the socket 20, and the outer ring 40 are strongly tightened and fastened with respect to each other.

When the flange 15h is pressed against the second seal portion 19 of the socket base 21 into tight contact with each other by the outer ring 40 in a state in which the seal member 30 is inserted into the first seal portion 18, the seal member 30 is flattened and the hermeticity between the first seal portion 18 of the flange 15h and the second seal portion 19 of the socket base 21 is enhanced. Since the seal member 30 is strongly flattened by the outer ring 40, further reliable waterproof is achieved in comparison with the case where the cap 150 and the mounting portion 23a are simply coupled.

In a state in which the outer ring 40 is attached, the globe 13 of the lamp unit 10 penetrates through the opening 40b of the outer ring 40 and projects therefrom. In this state, the inner peripheral surface 42b of the hook 42 is in the proximity of the peripheral wall 13d of the globe 13 so as to oppose thereto. The power is supplied through the socket 20 to the lamp unit 10, then is converted by the lighting circuit 17, and then is supplied to a plurality of the LED elements. Consequently, the plurality of LED elements arranged in the light-emitting portion 12a are turned ON. When a plurality of the LED elements are turned ON, light beams are emitted from the light-emitting portion 12a, and the light beams pass through the globe 13 and go out to the outside.

Heat generated by a plurality of the LED elements when being ON is transferred mainly to the first frame 11, and from the first frame 11 through the second frame 15 or the like to the outer ring 40. Since the outer ring 40 is formed of a metal, the transferred heat is dissipated efficiently to the outside.

The outer ring 40 is formed of a metal, and the hook 42 of the outer ring 40 is in contact with the flange 15h. Then, the inner peripheral surface 42b of the hook 42 is in proximity to the globe 13, and opposes thereto. Since the flange 15h and the globe 13 are formed of the insulating material, the insulating performance and pressure-resistant performance can be secured.

As described thus far, according to the luminaire 1 of the fourth embodiment, the flange 15h of the lamp unit 10 on which the seal member 30 is mounted is brought into tight contact with the socket base 21 with the hook 42 by coupling the outer ring 40 to the socket base 21 of the socket 20. Therefore, the luminaire 1 by itself made up of the lamp unit 10 and the socket 20 has a waterproof structure. At this time, even when the socket inner 23 is configured to be movable with respect to the socket base 21, the waterproof properties are secured. Since the luminaire 1 has the waterproof structure independently, the luminaire 1 can be used in the environment in which the luminaire 1 is subject to water, for example, outdoors even when not being covered with the outer casing having the waterproof structure.

According to the luminaire 1 of the fourth embodiment, the outer ring 40 is attached to the socket base 21 of the socket 20 to which the lamp unit 10 is coupled. Since flange 15h on which the seal member 30 is mounted is brought into tight contact with the socket base 21 with the hook 42 of the outer ring 40, the luminaire 1 is made watertight. The socket inner 23 and the cap 150 of the lamp unit 10 are accommodated in the place between the second frame 15 and the socket base 21 where is sealed by the seal member 30. Accordingly, for example, the socket inner 23 is configured to be movable with respect to the socket base 21, the electrically connected portion of the luminaire 1 is made waterproof.

In addition, according the luminaire 1 of the fourth embodiment the lamp unit 10 can be fastened strongly to the socket 20 by the outer ring 40. The lamp unit 10 can be reliably prevented from being loosened or coming apart from the socket 20. Also, by the outer ring 40 formed of a metal, heat generated by the light-emitting element of the semiconductor can be efficiently dissipated. Furthermore, the strength of the luminaire 1 is also improved.

Since the outer peripheral wall of the housing which constitutes the lamp unit 10 is formed of an insulating material, even when the hook 42 of the outer ring 40 formed of a metal approaches the outer peripheral wall of the lamp unit 10, the insulating performance and the pressure resistant performance are maintained. Since a portion from the flange 15h of the lamp unit 10 to the outer peripheral wall on the light-emitting side is formed of an insulating material, even when the hook 42 of the outer ring 40 formed of a metal comes into contact with the flange 15h of the lamp unit 10 or approaches the outer peripheral wall of the lamp unit 10, the insulating performance and the pressure-resistant performance are maintained.

The lamp unit 10 and the socket 20 are not limited to those supporting the GX53-type cap, and may be those supporting caps of other structures. The outer peripheral wall of the lamp unit 10 formed of an insulating material is not limited to a case of being formed by the peripheral wall 13d of the globe 13, and may be formed by extending part of the second frame 15, or may be a separate insulating member.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a lamp unit having a watertight structure, into which a light-emitting portion and a lighting circuit are builded, and on which a cap is formed in a range where a plug electrically connected to the lighting circuit projects;
a socket having a mounting portion for the cap and a terminal provided on the mounting portion, the terminal configured to be connected to the plug electrically when the cap is coupled to the mounting portion; and
a seal member attached along an outer peripheral portion of a joint surface between the cap and the mounting portion, and configured to seal a portion between the lamp unit and the socket with a watertight condition.

2. The luminaire according to claim 1, wherein
the cap comprises a boss protruding in a direction of projection of the plug and a first seal portion surrounding the plug and the boss;
the mounding portion comprises a connecting hole which allows insertion of the plug, a hollow fitted to the boss, and a second seal portion surrounding the connecting hole and the hollow; and
the seal member is inserted between the first seal portion and the second seal portion.

3. The luminaire according to claim 2, wherein
the first seal portion comprises a seal groove which opens toward the second seal portion, and
the seal member is put in the seal groove.

4. The luminaire according to claim 2, wherein
the boss comprises an engaging groove on an outer peripheral surface;
the hollow comprises an engaging projection to be fitted into the engaging groove on an inner peripheral surface.

5. The luminaire according to claim 1, further comprising:
an outer ring mounted on outer peripheries of the lamp unit and the socket including a range where the first seal portion and the second seal portion are formed and configured to be coupled to at least one of the lamp unit and the socket.

6. The luminaire according to claim 5, wherein
the lamp unit comprises a boss protruded in the direction of projection of the plug, a flange formed on an outer peripheral portion of the lamp unit about the boss as a center, and a first seal portion formed on the flange in a range facing the socket,
the socket comprises a connecting hole which allows insertion of the plug, a hollow fitted to the boss, and a second seal portion formed on the mounting portion in a range facing the first seal portion, and
the outer ring comprises a hook engaged with the flange, and a coupling portion to be coupled to an outer peripheral portion of the socket, and
the seal member is inserted between the first seal portion and the second seal portion, and is flattened when the outer ring is connected to the socket.

7. The luminaire according to claim 6, wherein
the first seal portion comprises the seal groove, and
the seal member is put in the seal groove.

8. The luminaire according to claim 5, wherein
the lamp unit comprises a boss protruding in the direction of projection of the plug and a first seal portion formed on the outer periphery of the cap so as to face the outer ring,
the socket comprises a connecting hole which allows insertion of the plug, a hollow fitted to the boss, and a second seal portion formed on the outer peripheral portion of the socket so as to face the outer ring,
the outer ring comprises a third seal portion facing the first seal portion and a fourth seal portion facing the second seal portion,
the seal member comprises a first seal member inserted between the first seal portion and the third seal portion, and a second seal member inserted between the second seal portion and the fourth seal portion.
